(19) United States
(12) Patent Application Publication
(10) Pub. No.: US 2008/0036292 A1
(43) Pub. Date: Feb. 14, 2008

(54) Braking pressure control unit for vehicle braking system

(76) Inventors: Moriharu Sakai, Kariya-city (JP); Tetsuya Yoshijima, Kariya-city (JP)

Correspondence Address: BUCHANAN, INGERSOLL & ROONEY PC, POST OFFICE BOX 1404, ALEXANDRIA, VA, 22313-1404, US

(21) Appl. No.: 11/882,426

(22) Filed: Aug. 1, 2007

(30) Foreign Application Priority Data
Aug. 11, 2006 (JP) 2006-220169
May 17, 2007 (JP) 2007-131485

(51) Int. Cl. B60T 13/16

(52) U.S. Cl. 303/11

(57) ABSTRACT

In a braking pressure control unit for a vehicle braking system, an electric motor is arranged at one side of a hydraulic pressure control block, while electromagnetic valves and an electronic control unit are arranged at the other side of thereof. A connector portion to be connected with an external terminal and an accommodation space are formed in a casing of the braking pressure control unit, such that the connector portion and the accommodation space protrude outwardly from an outer periphery of the hydraulic pressure control block in a direction perpendicular to a direction of a motor shaft of the electric motor, and that the accommodation space is neighboring to the connector portion. And a large-sized electrical part included in a motor driving circuit is accommodated in the accommodation space.

### CROSS REFERENCE TO RELATED APPLICATION

This application is based on Japanese Patent Application Nos. 2006-220169 filed on Aug. 11, 2006, and 2007-131485 filed on May 17, 2007, the disclosures of which are incorporated herein by reference.

### FIELD OF THE INVENTION

The present invention relates to a braking pressure control unit for a vehicle braking system, which controls brake fluid pressure for wheel cylinders in accordance with control signals from an electronic control unit.

### BACKGROUND OF THE INVENTION

A braking pressure control unit is applied to a vehicle braking system, which generally has a function for an anti-lock braking control (ABS), a function for a vehicle stability control (ESC), and so on. The braking pressure control unit is composed of a combination of a hydraulic pressure control block in which a pump and electromagnetic valves are assembled in a housing thereof, an electric motor for driving the pump, and an electronic control unit having a motor driving circuit and a valve control circuit. A valve which opens and/or closes a brake fluid line connecting a master cylinder to respective wheel cylinders, or a valve which controls brake fluid pressure in the respective wheel cylinders can be used as the above electromagnetic valve. A reservoir, a pressure sensor, and so on may be also assembled in the braking pressure control unit, as the case may be. The reservoir temporally stores the brake fluid discharged from the wheel cylinders.

According to conventional braking pressure control units, for example, as disclosed in Japanese Patent Publication Nos. H10-059152 and H10-278771, an electric motor is arranged at one side of the braking pressure control unit and an electronic control unit is arranged at the other side thereof, so that the electric motor and the electronic control unit oppose to each other.

Such a structure for a braking pressure control unit is proposed, in which an electric motor and an electronic control unit are arranged side by side in a motor shaft direction and on one side of the braking pressure control unit. In addition, the electronic control unit may be arranged at an outer periphery of the electric motor on the same side of the braking pressure control unit.

Furthermore, another type of the braking pressure control unit may be required depending on a vehicle in which the braking pressure control unit is mounted. In such type of the braking pressure control unit, as explained in relation to the above Japanese Patent Publications, the electric motor is arranged at one side of the braking pressure control unit and the electronic control unit is arranged at the other side thereof, so that the electric motor and the electronic control unit oppose to each other.

A problem may occur when a size of the braking pressure control unit becomes larger, and when it may become difficult, depending on a vehicle model, to mount the braking pressure control unit in an engine compartment of a vehicle. Accordingly, it is important to keep the size of the braking pressure control unit as small as possible. However, in the braking pressure control unit, in which the electric motor and the electronic control unit are arranged in the motor shaft direction, as disclosed in the above identified Japanese Patent Publications, a length of the electric motor and the electronic control unit in the motor shaft direction is likely to become longer. It is, therefore, effective to suppress the increase of the length of the braking pressure control unit in the motor shaft direction even by a small amount, so that the braking pressure control unit may not be easily affected by any limitations for mounting the same into the engine compartment.

When a brushless motor is used as the electric motor for driving the pump, a response is improved compared with a case of a brush type motor. Namely, a pressure increasing speed is increased to improve a response for a braking operation, when the pump is driven by the brushless motor. The brushless motor requires electrical parts, such as a condenser, a coil, and so on, which are necessary for a noise filter and generally large in size. When the electronic control unit, in which such electric parts having large sizes are included, is arranged in the motor shaft direction, the length of the braking pressure control unit becomes inevitably longer. And it may become more difficult to mount the braking pressure control unit in the engine compartment. In this view point, the brushless motor has a limit to be used for the braking pressure control unit.

### SUMMARY OF THE INVENTION

The present invention is made in view of the foregoing problems, and has an object to provide a braking pressure control unit for a vehicle, in which an electric motor is arranged at one side of the braking pressure control unit and an electronic control unit is arranged at the other side thereof, so that the electric motor and the electronic control unit oppose to each other, wherein the braking pressure control unit can be made as smaller as possible so that limitations for mounting the braking pressure control unit in an engine compartment may be reduced.

According to a feature of the present invention, a braking pressure control unit for a vehicle braking system has a pump for drawing brake fluid and for supplying the brake fluid to respective wheel cylinders, a hydraulic pressure control block, an electric motor of a brushless motor for driving the pump, and an electronic control unit for outputting control signals to the respective electromagnetic valves and to the electric motor for driving the pump. The hydraulic pressure control block includes first electromagnetic valves for controlling a pressure difference between an output pressure of the brake fluid from a master cylinder and fluid pressure in the wheel cylinders, and second electromagnetic valves for controlling fluid pressure of the brake fluid in the respective wheel cylinders, wherein valve portions of the electromagnetic valves and the pump are arranged in an inside of a housing for the hydraulic pressure control block.

In the above braking pressure control unit, the electric motor is arranged at one side of the hydraulic pressure control block, the electromagnetic valves as well as the electronic control unit are arranged at the other side of the hydraulic pressure control block, and the electronic control unit is composed of a printed circuit board having a motor driving circuit and a valve control circuit, and a casing for accommodating the printed circuit board.

In addition, in the above braking pressure control unit, a connector portion to be connected with an external terminal and an accommodation space neighboring to the connector portion are formed in the casing, such that the connector portion and the accommodation space protrude outwardly from an outer periphery of the hydraulic pressure control block in a direction perpendicular to a direction of a motor shaft of the electric motor. Furthermore, a large-sized electrical part included in the motor driving circuit is accommodated in the accommodation space.

According to an embodiment of the present invention, the above braking pressure control unit has furthermore the following features (1) to (3):

(1) The electromagnetic valves are put together in a group and arranged at an upper portion of the other side of the hydraulic pressure control block, the connector portion is arranged at an area horizontally adjacent to the group of the electromagnetic valves, and the accommodation space is formed below the connector portion.

(2) The motor driving circuit and the valve control circuit are formed on the common single printed circuit board, and the large-sized electrical part included in the motor driving circuit, which is accommodated in the accommodation space, is fixed to the printed circuit board.

(3) The large-sized electrical part is a noise filter provided in the motor driving circuit for a brushless motor, wherein the noise filter is composed of a condenser and a coil which are accommodated in the accommodation space.

(3-1) The noise filter is formed as a sub-assembly unit in which the condenser and the coil are fixed to bus bars, the noise filter is accommodated in the accommodation space, and the bus bars are connected to the motor driving circuit formed on the printed circuit board.

(3-2) The condenser and the coil are partially overlapped when viewed in a direction perpendicular to a plane of the printed circuit board, and the condenser and the coil are arranged in respective sub-spaces of the accommodation space, wherein the sub-spaces are displaced from each other in the direction perpendicular to the plane of the printed circuit board.

The present invention can be applied to such a braking pressure control unit, which has two pumps for respectively supplying brake fluid to respective wheel cylinders, and two electric motors for respectively driving the pumps, wherein two electric motors are arranged to be horizontally neighboring to each other.

The above-mentioned connector portion is inevitably necessary for connecting the braking pressure control unit with an electric power circuit, a control signal circuit and so on for a vehicle. In the conventional braking pressure control unit, the connector portion is provided in a main portion of the casing. The connector portion is provided such that the connector portion is protruded from an outer periphery of the hydraulic pressure control block in order that an external connector can be easily inserted into the connector portion. Accordingly, an area neighboring to the connector portion would otherwise become as a dead space, unless the accommodation space is provided. If it were the case, efficiency of using the space would be reduced. According to the present invention, however, the space neighboring to the connector portion is formed as the accommodation space, in which the large-sized electrical part included in the motor driving circuit is accommodated. As a result, the dead space is not generated to increase the efficiency of using the space. Therefore, the length in the motor shaft direction can be suppressed from becoming larger, even in the case that the brushless motor is used.

The condenser and the coil forming the noise filter are, in particular, large-sized electrical parts among electrical parts included in the motor driving circuit for the brushless motor. Accordingly, even in the braking pressure control unit having the accommodation space in which only the condenser and the coil are accommodated, the small-sized braking pressure control unit can be realized.

The sub-assembly unit of the noise filter, which is accommodated in the accommodation space, is furthermore advantageous in view of applying the noise filter to the various kinds of the braking pressure control units, which have different specifications.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic side view, including a partial cross sectional view, showing a braking pressure control unit according to an embodiment of the present invention;

FIG. 2 is a cross sectional view taken along a line II-II in FIG. 1;

FIG. 3 is a cross sectional view taken along a line III-III in FIG. 1;

FIG. 4 is a view showing an example of a hydraulic circuit for a vehicle braking system having a function of ESC;

FIG. 5 is a schematic circuit for a noise filter;

FIG. 6 is a cross sectional view taken along a line, corresponding to the line II-II for FIG. 2, wherein the noise filter is incorporated as a sub-assembly;

FIG. 7 is a top view showing the noise filter formed as the sub-assembly;

FIG. 8 is a side view of the noise filter of FIG. 7;

FIG. 9 is a top view showing an accommodated condition of a condenser and a coil according to another example;

FIG. 10 is a side view of the accommodated condition shown in FIG. 9;

FIG. 11 is a schematic side view showing the condenser which is arranged in a vertical direction; and

FIG. 12 is a schematic side view showing the condenser which is arranged in a horizontal direction.

### DETAILED DESCRIPTION OF THE PREFERRED EMBODIMENTS

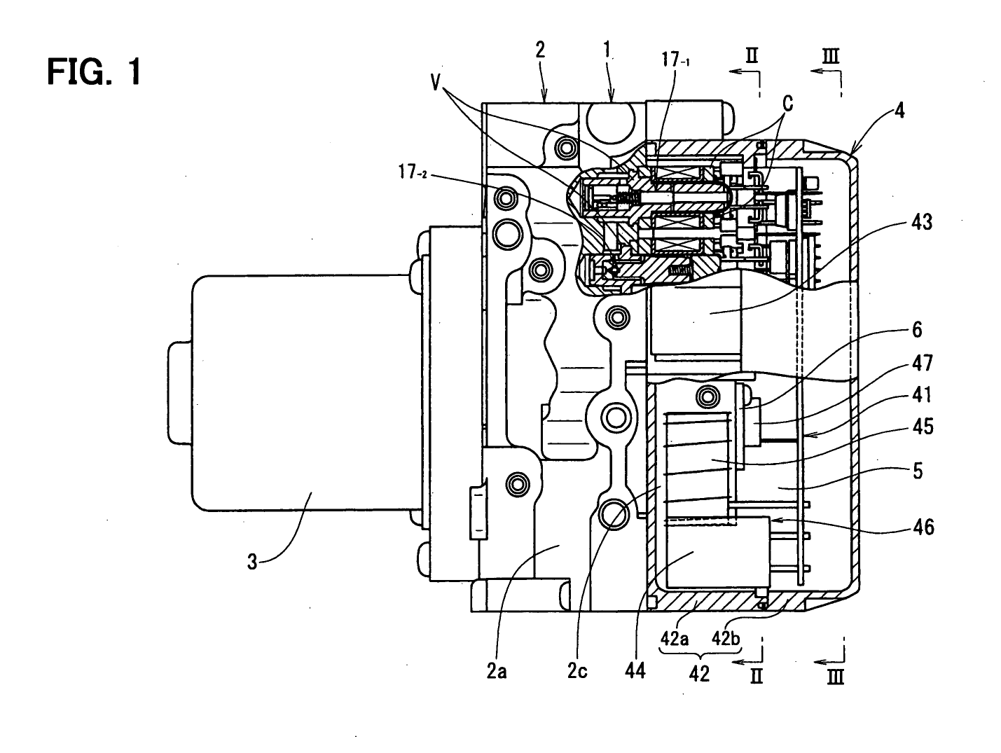

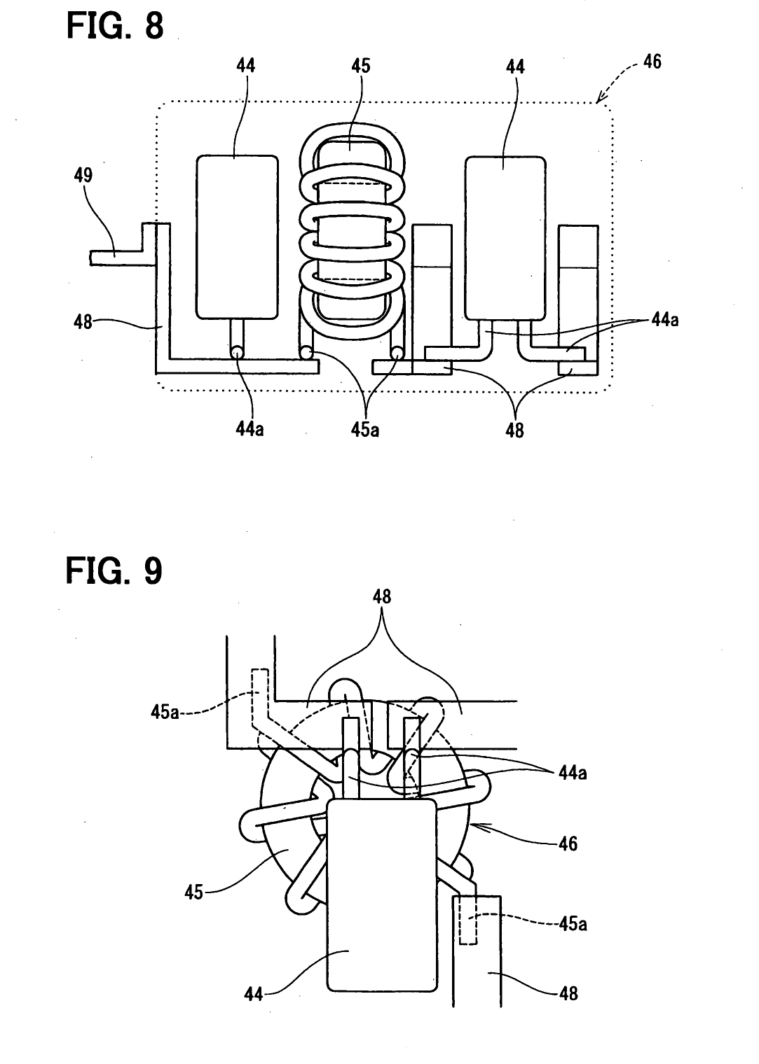

An embodiment of the present invention will be explained with reference to FIGS. 1 to 12 of the attached drawings.

For the convenience sake of the explanation, sub reference numerals (such as -1, -2, and so on) are added to respective main reference numerals, when there are a plurality of components which are identical or similar to each other, e.g. electromagnetic valves, pumps, and so on. The sub reference numerals are added to the main reference numerals so that the components having the same main reference numerals are distinguished from each other.

FIGS. 1 to 3 respectively show a braking pressure control unit 1 for a vehicle braking system according to the embodiment of the present invention. The braking pressure control unit 1 is composed of a hydraulic pressure control block 2, an electric motor 3, and an electronic control unit (ECU) 4.

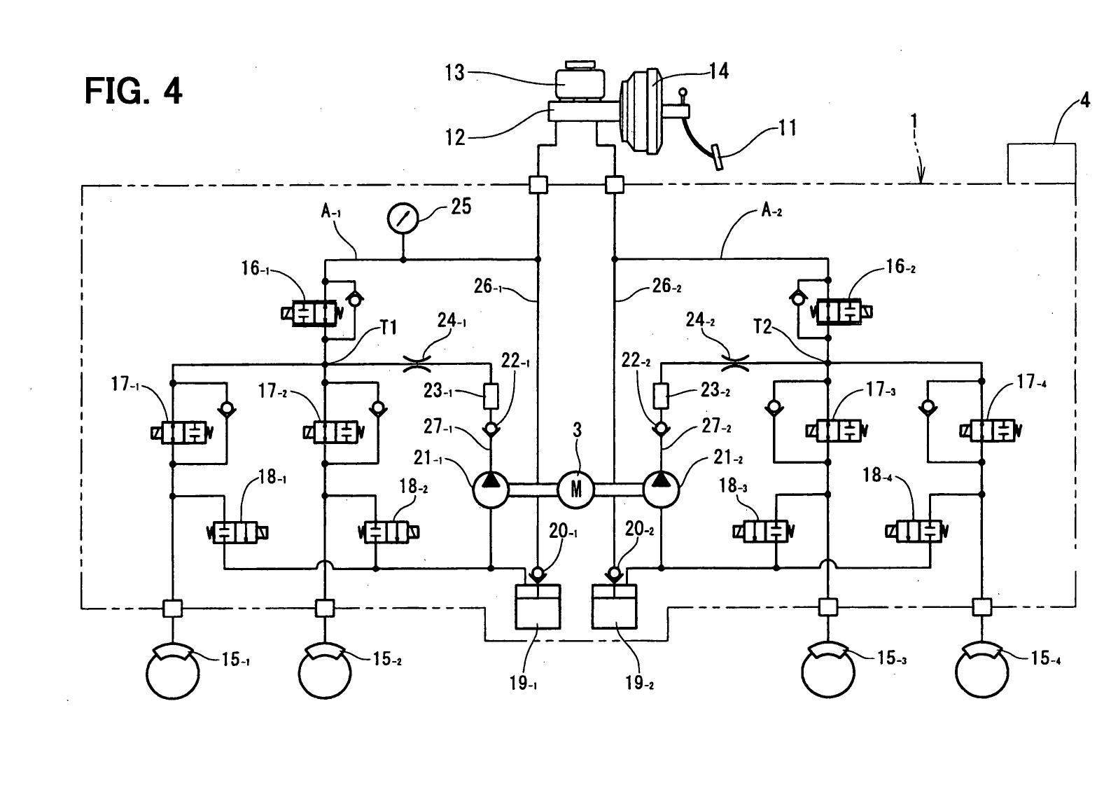

FIG. 4 shows an example of a hydraulic circuit for the vehicle braking system. The braking pressure control unit 1 shown in FIGS. 1 to 3 is applied to the vehicle braking system shown in FIG. 4. Therefore, the vehicle braking system shown in FIG. 4 will be explained at first.

In FIG. 4, a reference numeral 11 designates a brake pedal, a reference numeral 12 designates a master cylinder of a tandem type having a reservoir 13 for the master cylinder, and a reference numeral 14 designates a booster for operating the master cylinder 12 to magnify braking force applied by a vehicle driver and to increase a braking pressure.

Numerals 15-1 to 15-4 designate wheel cylinders for respective vehicle wheels. A-1 designates a first brake fluid circuit for operatively supplying the brake fluid from the master cylinder 12 to the wheel cylinders 15-1 and 15-2. A-2 designates a second brake fluid circuit for operatively supplying the brake fluid from the master cylinder 12 to the wheel cylinders 15-3 and 15-4.

Numerals 16-1 and 16-2 designate electromagnetic valves (linear control valves), each of which is provided in the first and second brake fluid circuits A-1 and A-2 at an upstream side of respective bifurcating points T1 and T2, that is a side closer to the master cylinder 12, and which are capable of performing a duty-ratio control.

Numerals 17-1 to 17-4 and 18-1 to 18-4 designate electromagnetic valves for respectively controlling the brake fluid pressure for the wheel cylinders 15-1 to 15-4. The electromagnetic valves 17-1 to 17-4 are normally-opened type valves for pressure increasing operation, whereas the electromagnetic valves 18-1 to 18-4 are normally-closed type valves for pressure decreasing operation.

The electromagnetic valves 16-1 and 16-2 may be replaced by ordinary electromagnetic on-off valves.

Numerals 19-1 and 19-2 designate reservoirs for temporally storing the brake fluid, which is discharged from the respective wheel cylinders through the electromagnetic valves 18-1 to 18-4. Numerals 20-1 and 20-2 designate control valves for opening or closing fluid supply lines 26-1 and 26-2, each of which communicates the reservoir 13 with the reservoirs 19-1 and 19-2 through the master cylinder 12. The control valves 20-1 and 20-2 shown in FIG. 4 are opened or closed depending on the increase or decrease of amount of the brake fluid in the reservoirs 19-1 and 19-2. The control valves 20-1 and 20-2 may be replaced by electromagnetic valves.

Numerals 21-1 and 21-2 designate pumps and a numeral 3 designates an electric motor for driving the pumps 21-1 and 21-2. Fluid discharge lines 27-1 and 27-2 for the pumps 21-1 and 21-2 are respectively connected to the first and second brake fluid circuits A-1 and A-2 at the bifurcated points T1 and T2. Check valves 22-1 and 22-2, dampers 23-1 and 23-2 for damping pulsation of fluid pumped out from the pumps 21-1 and 21-2, and orifices 24-1 and 24-2 are respectively provided in the fluid discharge lines 27-1 and 27-2. A numeral 25 designates a pressure sensor.

In the vehicle braking system as explained above, the first brake fluid circuit A-1 is connected to the wheel cylinders for both of the front wheels or the wheel cylinder 15-1 for a front left wheel and the wheel cylinder 15-2 for a rear right wheel. In a similar way, the second brake fluid circuit A-2 is connected to the wheel cylinders for both of the rear wheels or the wheel cylinder 15-3 for a front right wheel and the wheel cylinder 15-4 for a rear left wheel. In the vehicle having the above braking system, operations for an anti-lock braking control (ABS), a vehicle stability control (ESC), and so on will be carried out.

The structure and operation of the above vehicle braking system are disclosed in a prior art document, such as Japanese Patent Publication No. 2003-237557. Therefore, the detailed explanation for the operations for ABS, ESC and so on will be omitted.

The hydraulic pressure control block 2 of the braking pressure control unit 1, which is shown in FIGS. 1 to 3, is composed of components (except for the electric motor 3) framed by a two-dot chain line in FIG. 4, wherein those components are assembled into a housing 2a. The housing 2a has ports (not shown) at its upper portion, which are respectively connected to the master cylinder 12, the reservoir 13 for the master cylinder, and the wheel cylinders 15-1 to 15-4. Hydraulic passages (hydraulic lines) for the brake fluid, such as the brake fluid lines A-1 and A-2, the fluid discharge lines 27-1 and 27-2, and so on, which are indicated in FIG. 4 and framed by the two-dot chain line, are formed in an inside of the housing 2a. The pumps 21-1 and 21-2, which are formed as the tandem type pumps and arranged in parallel to each other, are also incorporated into the housing 2a. The other components shown in FIG. 4, such as valve portions V of the electromagnetic valves 16 to 18, the reservoirs 19-1 and 19-2, the check valves 22-1 and 22-2, the dampers 23-1 and 23-2, the orifices 24-1 and 24-2, and the pressure sensor 25 are likewise incorporated into the housing 2a.

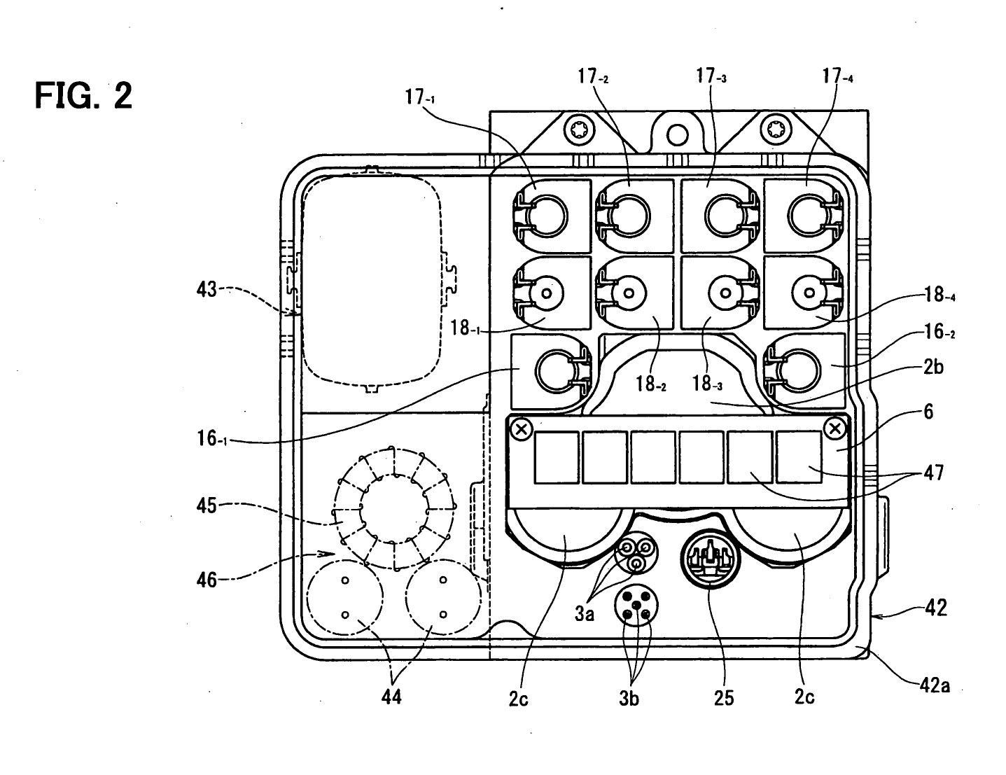

The electric motor 3 is a brushless motor and arranged at one side (one steep side) of the hydraulic pressure control block 2. The electromagnetic valves 16 to 18 and the electronic control unit 4 are arranged at the other side of the hydraulic pressure control block 2 (the opposite side to the electric motor 3). There are, all together, ten electromagnetic valves 16 to 18, which are put together in a group and arranged at the upper portion of the hydraulic pressure control block 2, as shown in FIG. 2. Each of the electromagnetic valves 16 to 18 is arranged in a horizontal direction, as shown in FIG. 1, and coil portions C of the electromagnetic valves 16 to 18 are outwardly protruded from the side surface of the housing 2a.

The ECU 4 is composed of a printed circuit board 41 and a casing 42. The printed circuit board 41 is composed of a single common circuit board, on which a driving circuit for the motor 3 as well as a valve control circuit for the respective electromagnetic valves are formed.

The casing 42 is fluid-tightly fixed to the housing 2a, more exactly screwed to the other side (the right hand side in FIG. 1) of the housing 2a. The casing 42 has a main portion 42a for accommodating the coil portions of the electromagnetic valves and a cover portion 42b for closing the main portion 42a. In FIG. 1, the main portion 42a and the cover portion 42b are thermally fusion bonded. The main portion 42a and the cover portion 42b may be integrally formed into one unit by any other methods. A connector portion 43 is provided in the main portion 42a and arranged adjacent to the electromagnetic valves.

The connector portion 43 is protruded from an outer surface of the hydraulic pressure control block 2 in a direction perpendicular to a motor shaft direction, more exactly, in a leftward direction in FIG. 2. A side of the connector portion 43 (a left-hand side in FIG. 1, that is, a back side in FIG. 2) is opened to the outside of the casing 42 in a direction in parallel to the motor shaft direction. An external connector (not shown) provided at one end of a wire harness is inserted into the connector portion 43 in the direction parallel to the motor shaft direction. The main portion 42a of the casing 42 is formed into an almost rectangular shape when viewed in the motor shaft direction, as seen from FIG. 2. An accommodation space 5 is formed below the connector portion 43.

A volume of the accommodation space 5 can be changed, when a width of the connector portion 43 is adjusted. The brushless motor generally includes three electric lines for power supply and five electric lines for control signals. Accordingly, the number of electric lines will be increased when the brushless motor is used, compared with the case in which a brush-type motor is used. In other words, the number of connecting terminals will be increased. According to the present embodiment, the width of the connector portion 43 is increased in order to satisfy the increased number of the connecting terminals. When the width of the connector portion 43 is increased, a sufficient amount for the volume of the accommodation space 5 is obtained and thereby fitting force between the external connector and the connector portion 43 can be enhanced. As a result, reliability of the connector portion 43 is increased.

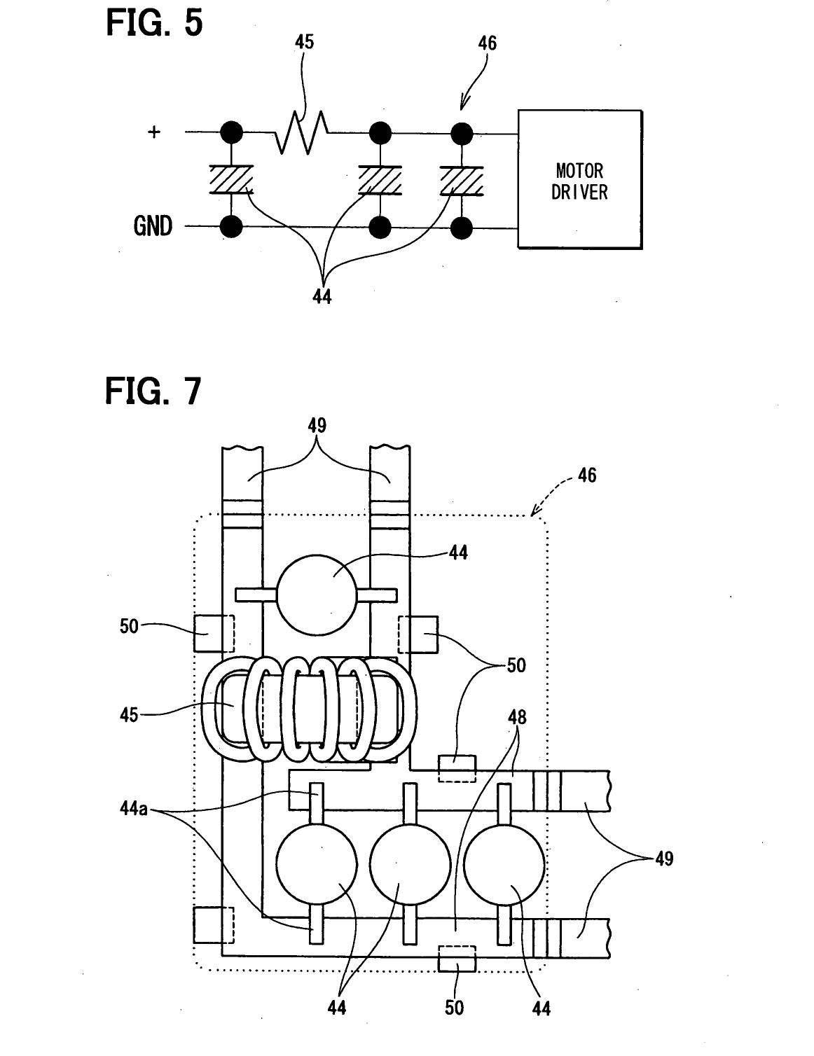

The motor driving circuit for the electric motor 3 (the driving circuit for the brushless motor) is disclosed, for example, in Japanese Patent No. 3100834. The detailed explanation for the driving circuit is omitted. Electrical parts for forming the electric circuit are included in the driving circuit of the electric motor 3. The electrical parts include, for example, a large volumetric condenser 44 and coil 45 for forming a noise filter 46 (FIG. 5). According to the braking pressure control unit 1 of the present embodiment, the condenser 44 and the coil 45 are mounted on the printed circuit board 41 and accommodated in the accommodation space 5. The condenser 44 and the coil 45 are those electrical parts, size of which is larger than the other electrical parts forming the driving circuit of the electric motor 3. As a result that those condenser 44 and the coil 45 are accommodated in the accommodation space 5 below the connector portion 43, a length of the ECU 4 in the motor shaft direction can be suppressed from becoming longer. In FIG. 2, the coil 45 is arranged at a higher position in the vertical direction than the condensers 44. However, the arrangement for the coil 45 and the condensers 44 may not be limited to the arrangement of FIG. 2. The coil 45 as well as the condensers 44 may be so arranged that a space efficiency becomes higher.

The valve control circuit for the electromagnetic valves as well as the driving circuit for the electric motor includes transistors 47, which are operated as semi-conductor relays. The transistors 47 are the electrical parts which generate heat during the operation. It is generally desired that thermal affection to the electronic control unit formed by the printed circuit board 41 is decreased. According to the embodiment, therefore, the housing 2a for the braking pressure control unit 1 is made of aluminum or aluminum alloy, so that the housing 2a absorbs the heat generated at the transistors 47.

A pump assembling portion 2b and a reservoir assembling portion 2c, which are shown in FIG. 2, are partially protruded from the other side surface (the right-hand surface in FIG. 1) of the housing 2a of the hydraulic pressure control block 2 in the motor shaft direction. A heat radiation plate 6 is so arranged as to be in contact with such protruded forward ends, and the transistors 47 are fixed to the heat radiation plate 6. As a result, heat radiation performance is high.

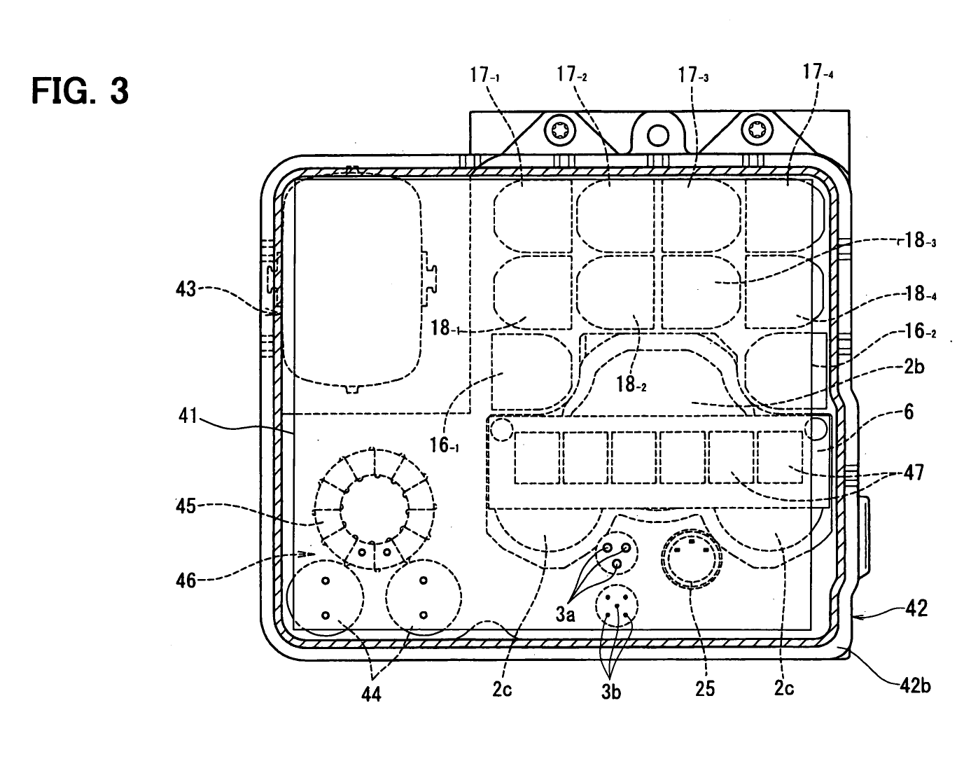

As shown in FIG. 3, the printed circuit board 41 has such a shape that the circuit board 41 is fitted to an inner shape of the cover portion 42b of the casing 42, so that the circuit board 41 is accommodated in the casing 42. As shown in FIG. 1, the circuit board 41 is arranged in parallel to the other side surface (the right-hand surface) of the housing 2a and at a position which is slightly displaced from the main portion 42a of the casing 42 in the motor shaft direction. The circuit board 41 is covered by the cover portion 42b of the casing 42.

The condensers 44 and the coil 45 are mounted onto a certain area of the printed circuit board. The condensers 44 and the coil 45 are put together in a specific area and accommodated in the accommodation space 5, when fixed to the printed circuit board 41.

Not only such electrical parts as having large sizes, but also all of the components for the motor driving circuit including the driving elements (that is, the transistors 47) can be accommodated in the accommodation space 5. In other words, all of the components for the motor driving circuit including the driving elements (that is, the transistors 47) can be put together in an area, which is a lower half portion of the printed circuit board 41 shown in FIG. 3. Namely, as a result that the electrical parts which need larger spaces are arranged in the accommodation space 5, which is formed below the connector portion 43, so-called dead spaces can be minimized. Therefore, the length of the braking pressure control unit in the motor shaft direction can be suppressed from becoming longer, even when the brushless motor is used.

In FIGS. 2 and 3, a reference numeral 3a designates terminals for electric power supply for the electric motor 3, and a reference numeral 3b designates terminals for the control signals. The terminals 3a and 3b are directly fixed to corresponding portions of the electric circuit formed on the circuit board 41. Terminals for the electromagnetic valves 16 to 18 as well as terminals for the pressure sensor 25 are likewise directly fixed to corresponding portions of the electric circuit formed on the circuit board 41. Accordingly, wiring for electric connection can be simplified and assembling process for the braking pressure control unit 1 can be made in a simpler manner.

According to the braking pressure control unit of the above embodiment, the electromagnetic valves 16, 17 and 18 are put together as a group and arranged at the specific portion. The connector portion 43 is arranged at the side of the portion for the electromagnetic valves. The accommodation space 5 is formed below the connector portion 43, so that the motor driving circuit as well as those electrical parts requiring the larger spaces are accommodated in the accommodation space 5. As a result, a protruding amount for the portion of the motor driving circuit in the motor shaft direction is prevented from becoming extremely larger than that for the electromagnetic valves. The length of the braking pressure control unit in the motor shaft direction is thereby suppressed to a small amount.

In the above braking pressure control unit, it is more advantageous when the ports for communicating the electromagnetic valves with the wheel cylinders are formed at the upper portion of the hydraulic pressure control block 2. According to such arrangement of the ports, the following processes may become easier. That is, the process for air evacuation from the hydraulic pressure control block 2, the process for connecting hydraulic pipes between the ports and the wheel cylinders, and so on.

According to the above embodiment, the group of the electromagnetic valves are arranged in such an area, which is on the other side of the hydraulic pressure control block 2 and at the upper portion thereof. Therefore, number of parts which are arranged between the electromagnetic valves and the ports can be easily reduced, compared with the case in which the group of the electromagnetic valves are arranged in such an area, which is on the other side of the hydraulic pressure control block 2 but at is a lower portion thereof. The electromagnetic valves and the ports are communicated by a simple structure of fluid passages, and the hydraulic pressure control block 2 can be made smaller in size.

According to the above embodiment, it is not necessary to displace the motor driving circuit from the valve control circuit in the motor shaft direction. In other words, the motor driving circuit and the valve control circuit can be formed on the same single printed circuit board. As a result, electronic communication between the motor driving circuit and the valve control circuit can be made easier and the circuit structure for the electronic communication can be also simplified.

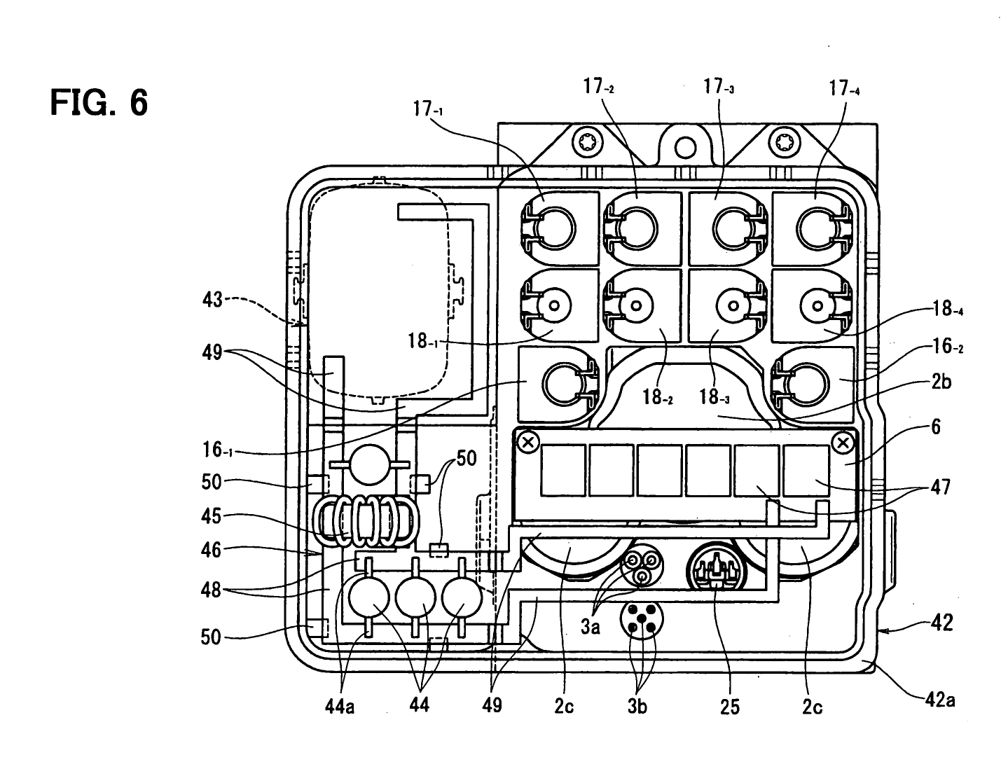

FIGS. 6 to 8 show an example, in which a noise filter 46 is assembled as a sub-assembly unit and fixed to the hydraulic pressure control block 2. The sub-assembly unit means such a portion, which has multiple parts to perform a function of the noise filter, and which is assembled in advance. The noise filter 46 is formed by the condensers 44 and the coil 45, which are incorporated into the electric circuit by means of bus bars 48. The noise filter 46 is formed at the lower side of the connector portion 43 and accommodated in the accommodation space 5.

Two bus bars 48 form a pair. Lead terminals 44a of the condensers 44 and lead terminals 45a of the coil 45 are respectively fixed to the pair of the bus bars 48 by soldering, or the like. As shown in the drawings, when the condensers 44 and the coil 45 are supported by the bus bars 48, there is no need for a specific supporting board for the condensers 44 and the coil 45. Therefore, it is advantageous to reduce cost and weight. However, it may be, of course, possible to provide a separate supporting board (not shown) independently from the printed circuit board 41, to which the condensers 44, the coil 45 and the bus bars 48 may be fixed.

Both ends of the bus bars 48 are connected by welding or the like to other bus bars 49, which are provided on the side of the printed circuit board 41 forming the motor driving circuit. The bus bars 48 are supported by the casing 42 at several points 50 in a longitudinal direction. Stability of the supporting portions 50, at which the bus bars 48 are supported by the casing 42, as well as molding properties for the casing 42, which is made of resin, may be preferably taken into consideration.

As a result that the noise filter 46 is provided as the sub-assembly unit as above, it becomes more advantageous when coping with changes of specifications for the braking pressure control unit. More exactly, in the case that it is required, depending on a different model of the vehicle, for the braking pressure control unit to replace the electric motor 3 shown in FIG. 1 with another electric motor having a different output characteristic, some of the other related electrical parts, such as the noise filter 46 and the transistors 47, are correspondingly necessary to be replaced by those electrical parts to fit to the replaced electric motor. Even in such a case, the sub-assembly unit for the noise filter 46 can be simply replaced.

In the braking pressure control unit shown in FIGS. 6 to 8, since the transistors 47 are fixed to the heat radiation plate 6, the transistors 47 can be replaced at one time by new ones together with the heat radiation plate 6. Accordingly, the specifications for the braking pressure control unit can be changed without changing the casing 42 as well as the printed circuit board 41. The cost reduction is also realized by communization of the electrical parts (the printed circuit board). A miniaturization of the printed circuit board can be also realized when some of the electrical parts are arranged at an outside of the printed circuit board.

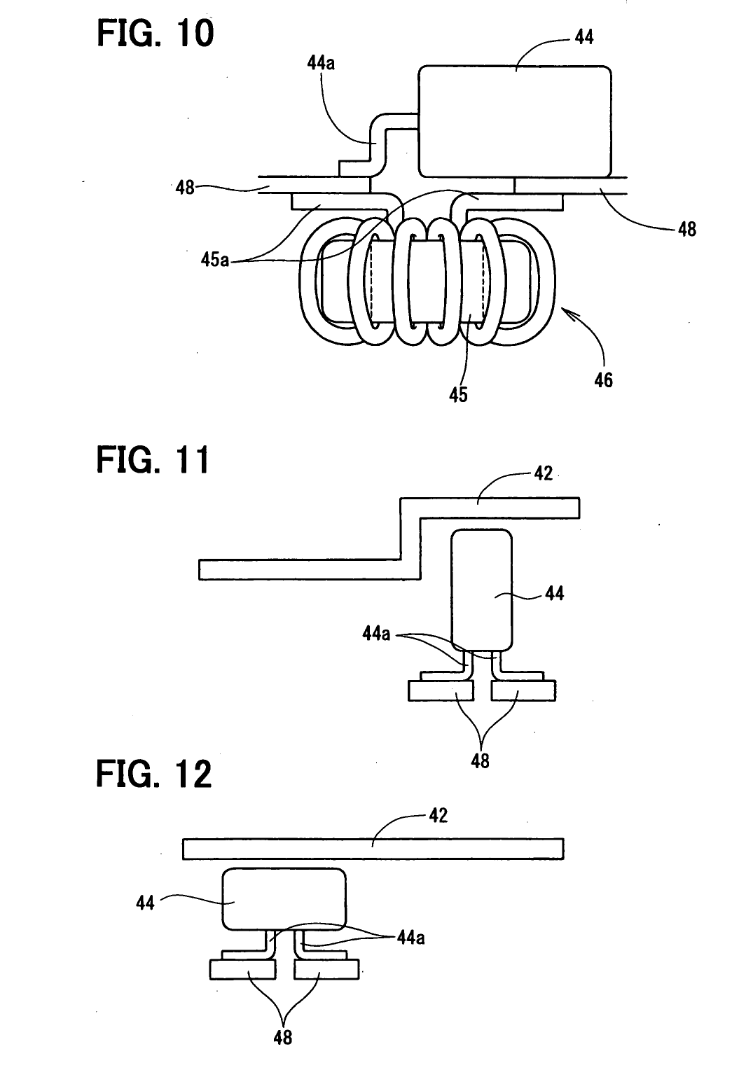

FIGS. 9 and 10 show an example, in which the condenser 44 and the coil 45 of the noise filter 46 are accommodated in the accommodation space 5 in such a manner that the condenser 44 and the coil 45 are partly overlapped when viewed in a direction perpendicular to the printed circuit board. In other words, the condenser 44 and the coil 45 are respectively accommodated in two sub-spaces of the accommodation space 5, in which the two sub-spaces are displaced from each other in the direction perpendicular to the printed circuit board. According to such an arrangement, the accommodation space 5 can be more effectively used, so that the electronic control unit can be made smaller in size.

Selection of the condenser 44 and the coil 45 also contributes to a reduction of the size. For example, configurations of the lead terminals 44a of the condenser 44 may be changed (or selected), so that a vertical arrangement (FIG. 11) or a horizontal arrangement (FIG. 12) may be chosen depending on the circumstances. There are several kinds of different shapes for the condenser 44, namely there are the shape having a larger width but a smaller height and the shape having a smaller width but a taller height, even though they have the same performance. The shape of the condenser 44 can be also flexibly selected. The same is applied to the coil 45. The accommodation space 5 can be more effectively used by an optimum arrangement of the condenser 44 and the coil 45, by considering the shape and the configurations of the lead terminals. It is also possible to form the configuration of the lead terminals of the electrical parts (such as the condenser 44) in an unsymmetrical shape, so that an erroneous assembling (for example, polarity is reversed) may be avoided.

It may be also possible to provide multiple pumps in view of a further improvement of the function or an increase of reliability in an aspect of fail-safe. More exactly, the pumps are provided for the respective wheel cylinders, those pumps are divided into two groups and driven by two electric motors. The number of electric motors may be further increased. The present invention can be applied to the braking pressure control unit having a plurality of electric motors. The size of the braking pressure control unit will be remarkably increased, when a plurality of brushless motors are used, and therefore such a braking pressure control unit having multiple brushless motors have to solve more limitations in terms of the size. The problems, however, can be solved by use of the present invention.

What is claimed is:

1. A braking pressure control unit for a vehicle braking system comprising:
a pump for drawing brake fluid and for supplying the brake fluid to respective wheel cylinders;
a hydraulic pressure control block including;
first electromagnetic valves for controlling a pressure difference between an output pressure of the brake fluid from a master cylinder and fluid pressure in the wheel cylinders;
second electromagnetic valves for controlling fluid pressure of the brake fluid in the respective wheel cylinders; and
a housing, in which valve portions of the electromagnetic valves and the pump are arranged;
an electric motor being composed of a brushless motor for driving the pump; and
an electronic control unit for outputting control signals to the respective electromagnetic valves and to the electric motor for driving the pump,
wherein the electric motor is arranged at one side of the hydraulic pressure control block, and the electromagnetic valves as well as the electronic control unit are arranged at the other side of the hydraulic pressure control block,
wherein the electronic control unit is composed of a printed circuit board having a motor driving circuit and a valve control circuit, and a casing for accommodating the printed circuit board,
wherein a connector portion to be connected with an external terminal and an accommodation space neighboring to the connector portion are formed in the casing, such that the connector portion and the accommodation space protrude outwardly from an outer periphery of the hydraulic pressure control block in a direction perpendicular to a direction of a motor shaft of the electric motor, and
wherein a large-sized electrical part included in the motor driving circuit is accommodated in the accommodation space.

2. A braking pressure control unit according to claim 1, wherein
the electromagnetic valves are put together in a group and arranged at an upper portion of the other side of the hydraulic pressure control block,
the connector portion is arranged at an area horizontally adjacent to the group of the electromagnetic valves, and
the accommodation space is formed below the connector portion.

3. A braking pressure control unit according to claim 2, wherein
the motor driving circuit and the valve control circuit are formed on the common single printed circuit board, and
the large-sized electrical part included in the motor driving circuit, which is accommodated in the accommodation space, is fixed to the printed circuit board.

4. A braking pressure control unit according to claim 3, wherein
the large-sized electrical part is a noise filter being composed of a condenser and a coil.

5. A braking pressure control unit according to claim 4, wherein
the noise filter is formed as a sub-assembly unit in which the condenser and the coil are fixed to bus bars,
the noise filter is accommodated in the accommodation space, and
the bus bars are connected to the motor driving circuit formed on the printed circuit board.

6. A braking pressure control unit according to claim 5, wherein
the condenser and the coil are partially overlapped when viewed in a direction perpendicular to a plane of the printed circuit board, and
the condenser and the coil are arranged in respective sub-spaces of the accommodation space, wherein the sub-spaces are displaced from each other in the direction perpendicular to the plane of the printed circuit board.

7. A braking pressure control unit according to claim 2, wherein
the large-sized electrical part is a noise filter being composed of a condenser and a coil.

8. A braking pressure control unit according to claim 7, wherein
the noise filter is formed as a sub-assembly unit in which the condenser and the coil are fixed to bus bars,
the noise filter is accommodated in the accommodation space, and
the bus bars are connected to the motor driving circuit formed on the printed circuit board.

9. A braking pressure control unit according to claim 8, wherein
the condenser and the coil are partially overlapped when viewed in a direction perpendicular to a plane of the printed circuit board, and
the condenser and the coil are arranged in respective sub-spaces of the accommodation space, wherein the sub-spaces are displaced from each other in the direction perpendicular to the plane of the printed circuit board.

10. A braking pressure control unit according to claim 2, wherein
two pumps are provided for respectively supplying the brake fluid to respective wheel cylinders, and
two electric motors are provided for respectively driving the pumps.

11. A braking pressure control unit according to claim 1, wherein
the motor driving circuit and the valve control circuit are formed on the common single printed circuit board, and
the large-sized electrical part included in the motor driving circuit, which is accommodated in the accommodation space, is fixed to the printed circuit board.

12. A braking pressure control unit according to claim 11, wherein
the large-sized electrical part is a noise filter being composed of a condenser and a coil.

13. A braking pressure control unit according to claim 12, wherein
the noise filter is formed as a sub-assembly unit in which the condenser and the coil are fixed to bus bars,
the noise filter is accommodated in the accommodation space, and
the bus bars are connected to the motor driving circuit formed on the printed circuit board.

14. A braking pressure control unit according to claim 13, wherein
the condenser and the coil are partially overlapped when viewed in a direction perpendicular to a plane of the printed circuit board, and
the condenser and the coil are arranged in respective sub-spaces of the accommodation space, wherein the sub-spaces are displaced from each other in the direction perpendicular to the plane of the printed circuit board.

15. A braking pressure control unit according to claim 11, wherein
two pumps are provided for respectively supplying the brake fluid to respective wheel cylinders, and
two electric motors are provided for respectively driving the pumps.

16. A braking pressure control unit according to claim 1, wherein
the large-sized electrical part is a noise filter being composed of a condenser and a coil.

17. A braking pressure control unit according to claim 16, wherein
the noise filter is formed as a sub-assembly unit in which the condenser and the coil are fixed to bus bars,
the noise filter is accommodated in the accommodation space, and
the bus bars are connected to the motor driving circuit formed on the printed circuit board.

18. A braking pressure control unit according to claim 17, wherein
the condenser and the coil are partially overlapped when viewed in a direction perpendicular to a plane of the printed circuit board, and
the condenser and the coil are arranged in respective sub-spaces of the accommodation space, wherein the sub-spaces are displaced from each other in the direction perpendicular to the plane of the printed circuit board.

19. A braking pressure control unit according to claim 16, wherein
two pumps are provided for respectively supplying the brake fluid to respective wheel cylinders, and
two electric motors are provided for respectively driving the pumps.

20. A braking pressure control unit according to claim 1, wherein
two pumps are provided for respectively supplying the brake fluid to respective wheel cylinders, and
two electric motors are provided for respectively driving the pumps.
